(19) United States
(12) Patent Application Publication
(10) Pub. No.: US 2026/0288499 A1
(43) Pub. Date: Sep. 24, 2026

(54) DATA PROCESSING METHOD AND APPARATUS

(71) Applicant: Lenovo (Beijing) Limited, Beijing (CN)

(72) Inventors: Meng WU, Beijing (CN); Yu ZHANG, Beijing (CN)

(21) Appl. No.: 19/459,715

(22) Filed: Jan. 26, 2026

(30) Foreign Application Priority Data
Mar. 20, 2025 (CN) 202510336430.9

(51) Int. Cl. G06F 9/451; G06F 3/048; G06F 40/30; G06N 20/00

(52) U.S. Cl. CPC G06F 9/453; G06F 3/048; G06F 40/30; G06N 20/00

(57) ABSTRACT

A data processing method includes obtaining an operation by a user on currently displayed content, the operation having associated content, and obtaining user behavior data within a specified period based on the operation. The user behavior data is implicit interaction data collected based on one or more control operations performed by the user using an input device while accessing the currently displayed content, and the implicit interaction data characterizes interested content of the user. The method further includes determining user intent data based on the user behavior data and the associated content.

### CROSS-REFERENCE TO RELATED APPLICATION

This application claims priority to Chinese Patent Application No. 202510336430.9, filed on Mar. 20, 2025, the entire content of which is incorporated herein by reference.

### TECHNICAL FIELD

The present disclosure generally relates to the field of artificial intelligence technology and, more particularly, to a data processing method and apparatus.

### BACKGROUND

During work, situations often arise that additional information or data support is needed. For example, when reviewing a technical document, one might encounter unfamiliar terminology and need to pause current task and actively search for relevant information using search engines or other resources. This process significantly impacts user productivity.

### SUMMARY

In accordance with the disclosure, there is provided a data processing method including obtaining an operation by a user on currently displayed content, the operation having associated content, and obtaining user behavior data within a specified period based on the operation. The user behavior data is implicit interaction data collected based on one or more control operations performed by the user using an input device while accessing the currently displayed content, and the implicit interaction data characterizes interested content of the user. The method further includes determining user intent data based on the user behavior data and the associated content.

Also in accordance with the disclosure, there is provided an electronic device including a processor, and a memory storing instructions that, when executed by the processor, cause the electronic device to obtain an operation by a user on currently displayed content, the operation having associated content, and obtain user behavior data within a specified period based on the operation. The user behavior data is implicit interaction data collected based on one or more control operations performed by the user using an input device while accessing the currently displayed content, and the implicit interaction data characterizes interested content of the user. The instructions, when executed by the processor, further cause the electronic device to determine user intent data based on the user behavior data and the associated content.

Also in accordance with the disclosure, there is provided a non-transitory computer-readable storage medium storing a computer program that, when executed by one or more processors, causes the one or more processors to obtain an operation by a user on currently displayed content, the operation having associated content, and obtain user behavior data within a specified period based on the operation. The user behavior data is implicit interaction data collected based on one or more control operations performed by the user using an input device while accessing the currently displayed content, and the implicit interaction data characterizes interested content of the user. The computer program, when executed by the one or more processors, further causes the one or more processors to determine user intent data based on the user behavior data and the associated content.

### BRIEF DESCRIPTION OF THE DRAWINGS

To more clearly illustrate the technical solutions in the embodiments of the present disclosure, the drawings for the description of the present disclosure will be briefly introduced below. Obviously, the drawings in the following description are merely embodiments of the present disclosure, and those skilled in the art can obtain other drawings based on the provided drawings without creative effort.

FIG. 1 is a flowchart of a data processing method consistent with the present disclosure.

FIG. 2 shows examples of various first operations for selecting content consistent with the present disclosure.

FIG. 3 is a flowchart showing determination of user intent consistent with the present disclosure.

FIG. 4 schematically shows an overall implementation architecture of user intent inference consistent with the present disclosure.

FIG. 5 schematically shows an example of presenting reference data consistent with the present disclosure.

FIG. 6 schematically shows another example of presenting reference data consistent with the present disclosure.

FIG. 7 is a flowchart of personalized adaptation of the data processing solution consistent with the present disclosure.

FIG. 8 is a schematic structural diagram of a data processing apparatus consistent with the present disclosure.

FIG. 9 is a schematic structural diagram of an electronic device consistent with the present disclosure.

### DETAILED DESCRIPTION OF THE EMBODIMENTS

The technical solutions in the embodiments of the present disclosure will be described below with reference to the accompanying drawings. Obviously, the described embodiments are only some embodiments of the present disclosure, and not all of them. Based on the described embodiments, all other embodiments obtained by those skilled in the art without making creative efforts are within the scope of the present disclosure.

The embodiments of the present disclosure can be applied to electronic devices. The present disclosure does not limit the product form of the electronic device, which may include, but is not limited to, smartphones, tablet computers, wearable devices, personal computers (PCs), netbooks, etc., and can be selected according to application needs.

The present disclosure provides a data processing method to address the situation where users encounter difficulties understanding or interpreting section of text within displayed content when accessing it on electronic devices, requiring additional supporting information for clarification. The method aims to better support users' understanding and clarification of displayed content during access, thereby improving access efficiency.

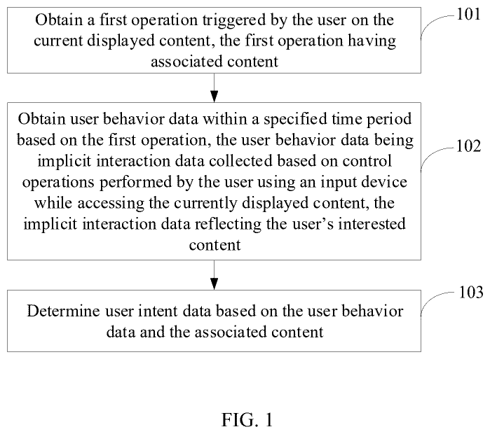

FIG. 1 is a flowchart of a data processing method consistent with the present disclosure. As shown in FIG. 1, the data processing method includes the following.

At 101, a first operation triggered by the user on the current displayed content is obtained, where the first operation has associated content.

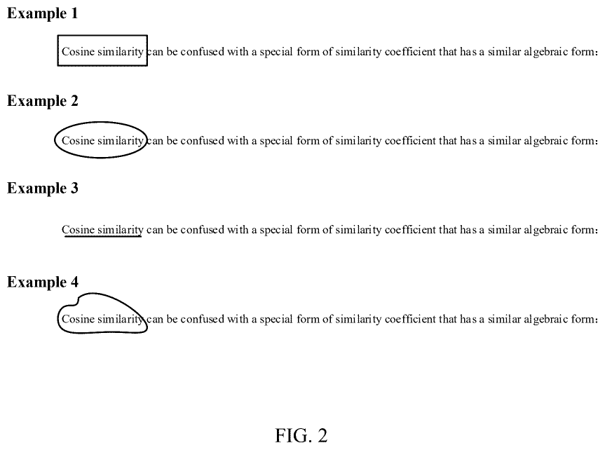

The current displayed content can be document content, web page display content, or display content of other related applications that can display text. The present disclosure does not impose any limitations on this. The first operation triggered by the user on the currently displayed content can be an operation that allows selecting or highlighting one or more text content, i.e., the first operation can be a content selection operation. This content selection operation may include, but is not limited to, operations such as box selection, circle selection, highlighting, and underlining. FIG. 2 shows examples of various first operations for selecting content consistent with the present disclosure.

The first operation has associated content, which includes at least the content selected by the content selection operation, such as “cosine similarity” in FIG. 2. In some embodiments, in addition to the content selected by the first operation, the associated content may also include the context of the selected content, such as the paragraph containing the selected content, or the paragraph containing the selected content along with the preceding and succeeding paragraphs.

In practical applications, the data processing solution in the present disclosure can be configured to be enabled or disabled. Only when the data processing solution is enabled will the user's first operation trigger subsequent processes, and selection marks (such as a box or line) will be displayed on the currently displayed content based on the first operation triggered by user. When the data processing solution is disabled, the same first operation by the user will not trigger subsequent related processing, nor will a selection mark be displayed on the currently displayed content.

At 102, user behavior data within a specified time period is obtained based on the first operation. The user behavior data is implicit interaction data collected based on control operations performed by the user using an input device while accessing the currently displayed content. This implicit interaction data can reflect the user's interested content.

When viewing displayed content, users often perform some unconscious actions. For example, when viewing a passage of text, they usually move the cursor along the text as they silently read it; or, when viewing a section of text, the user may suddenly recall associated content that appeared earlier, and then move the cursor from the current position to the associated content in the previous section and click the left mouse button; or, after viewing the current paragraph for a long time, the user controls the mouse wheel to switch the displayed content. Although these control operations on the input device do not involve actual interaction with the displayed content, they can reflect the user's viewing position or focus to a certain extent, which can be referred to as the user's implicit interaction data. This implicit interaction data can be automatically collected by the device when the user accesses the displayed content, to assist in subsequently determining the user's interested content.

User behavior data is collected in real time during the user's viewing or editing of displayed content. However, considering data storage costs and the fact that user behavior data from a long time ago has no correlation with the user's intent corresponding to the first operation triggered by the current user, and may affect the accuracy of intent determination for the first operation triggered by the current user, in the embodiments of the present disclosure, only user behavior data within a specified time period is obtained after the user triggers the first operation. The specified time period can be a fixed duration extending backward from the current time, such as the last 3 minutes or the last 2 minutes.

At 103, user intent data is determined based on the user behavior data and the associated content.

After the user behavior data is obtained, the user intent data can be determined by incorporating the user behavior data and the associated content. For example, when the associated content of the first operation triggered by the user is “deep learning,” and the user behavior data indicates that the user moved the cursor over “deep learning” twice, it can be determined that the user may not fully understand the meaning of “deep learning,” and the user intent data is determined to be an explanation of the concept of “deep learning.” Another example is when the associated content of the first operation triggered by the user is the sales data of a particular manufacturer, then the user intent data can be determined to be obtaining sales data from similar companies for comparison.

In the data processing method described in the present disclosure, when a user triggers a first operation on the currently displayed content, user behavior data within a specified time period is obtained, and the user intent is comprehensively determined by incorporating the user behavior data and the associated content of the first operation. Since user behavior data is implicit interaction data that reflects the content user is interested in, using user behavior data as the basis for determining user intent can further improve the accuracy of intent inference.

As described above, obtain user behavior data within a specified time period based on the first operation may include: obtaining user behavior data within a specified time period before the user triggers the first operation based on the first operation. The user behavior data includes at least one of the following: current content access status data, cursor movement data, and page scrolling data. The user behavior data has a fixed data structure.

Considering that user behavior data from a long time ago has little correlation with the user's intent at the moment of triggering the first operation, and may reduce the accuracy of intent inference based on the first operation, in the present disclosure, the specified time period can be a fixed duration of time preceding the moment the user triggers the first operation.

The current content access status data may include, but is not limited to, the viewing duration per character of the currently displayed content, the relative viewing duration per character, the input duration per character, and the relative input duration per character. The cursor movement data may include, but is not limited to, cursor hovering (hovering without clicking), text selection with the cursor, and cursor position changes.

Specifically, user behavior involved in accessing the currently displayed content may include the following.
Viewing duration per character: total document or content viewing duration/number of characters; cumulative average speed under similar tasks.
Relative viewing duration per character: viewing duration of a certain passage of text/number of characters; if the relative viewing duration per character is greater than the baseline level, it indicates in-depth processing and thinking, which may involve intents related to this passage of text.
Input duration per character: total document or content input duration/number of characters; cumulative average speed under similar tasks.
Relative input duration per character: input duration of a certain passage of text/number of characters; if the relative input duration per character is greater than the baseline level, it indicates in-depth processing and thinking, which may involve intents related to this passage of text;
Mouse hovering (hovering without clicking): this reflects the behavior of reading word by word and sentence by sentence. This involves deeper processing and more careful consideration, and is more likely to involve intents related to this passage of text.
Mouse selection: this acts as a trigger for inferring intent, confirming that the inference of intent is related to the selected text;
Page scrolling: Repeatedly viewing a section of content; the viewing duration per character needs to be accumulated, and the number of views also needs to be included.
Cursor position changes: This may indicate a change in topic (or subtopic). If the topic of the text before and after the cursor position change is inconsistent, a content changes should be considered. The cursor position also reflects repeated viewing and thinking about the context.

Of course, in addition to the user behavior data mentioned above, actual applications can also include other implicit interaction data, such as user eye-tracking data. Eye-tracking data can reflect where the user's eyes are focused, revealing their interested content. For example, eye-tracking behavior recorded by an external eye-tracking device connected to an electronic device may include: gaze, saccades, etc.

In order for the above user behavior data to be applied to subsequent intent inference analysis and calculations, a data structure that can be recognized by machines is needed to represent the user behavior data. For example, the behavioral data corresponding to each text section is arranged in the following order: <Viewing duration (seconds), viewing duration per character (seconds/character), relative viewing duration per character (multiple), Mouse Hovering (number of times), mouse selection (content), page scrolling (number of views+total duration), Number of cursor position changes, eye-tracking (number of gazes+total duration+number of saccades), other behaviors (custom fields)>.

### Example

Text: “The user is reading a technical document about optimization solutions for AI models.”
Behavioral data: <60, 0.6, 0.8, 2, “None”, “3 times+20 seconds”, 1, “8 times+40 seconds+12 times”, “None”>.
Text: “The user selected ‘deep learning’.”
Behavioral data: <10, 0.2, 0.3, 1, “Deep learning”, “None”, 0, “1 time+5 seconds+2 times”, “None”>
Text: “The user returned to the previous section to confirm.”
Behavioral data: <40, 0.4, 0.5, “None”, “1 time+10 seconds”, 0, “3 times+15 seconds +4 times”, “None”>.

The above user behavior data can be applied to subsequent user intent inference tasks. Since user behavior data can, to some extent, reflect the content the user is interested in, it helps in better understanding user intent.

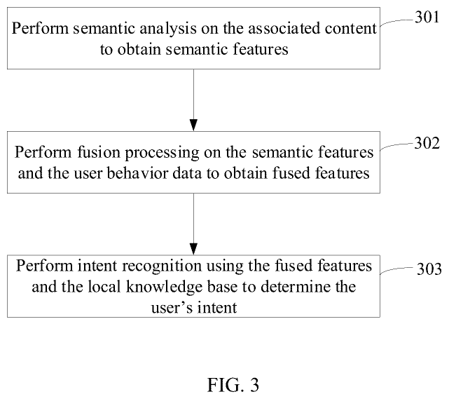

FIG. 3 is a flowchart showing determination of user intent consistent with the present disclosure. As shown in FIG. 3, determining user intent based on the user behavior data and the associated content includes the following.

At 301, semantic analysis is performed on the associated content to obtain semantic features.

The first operation is an active interaction by the user during the process of accessing the displayed content, such as highlighting or selecting text. The associated content includes at least the content selected in the first operation triggered by the user, and may also include context of the content selected in the first operation.

Consistent with the present disclosure, when performing intent inference, semantic analysis is first performed on the associated content to obtain semantic features; that is, the associated content needs to be analyzed first, the user's intent is inferred by incorporating the relevant context.

At 302, the semantic features and user behavior data are fused and processed to obtain fused features.

Determining user intent simply based on analysis of associated content has a certain error rate. Therefore, in the present disclosure, when inferring user intent, not only are the semantic features corresponding to the associated content used, but user behavior data is also incorporated for comprehensive analysis. Specifically, the semantic features and user behavior data can be fused to obtain fused features.

At 303, intent recognition is performed using the fused features and the local knowledge base to determine the user's intent.

After the fused features are obtained, the local knowledge base can be used as a reference to further determine the user's intent. For example, for associated content on “deep learning,” if the local knowledge base (which can be understood as a personal knowledge base) contains a large amount of content about deep learning, it can be determined that the user has already understood the basic concepts of deep learning, and the user's true intent in triggering the first operation is more likely to be to gain a deeper understanding of “deep learning”. If the local knowledge base does not contain relevant content on deep learning, it can be determined that the user is encountering “deep learning” for the first time and needs to understand its basic concepts.

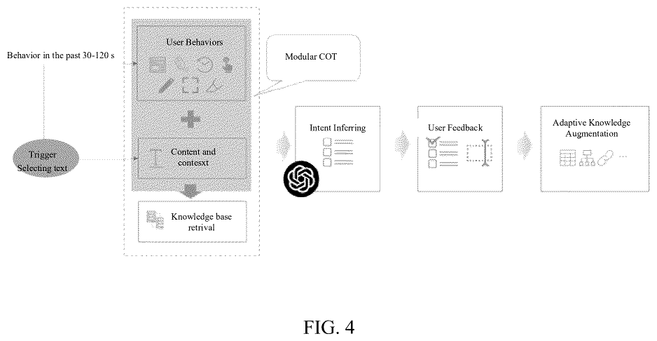

FIG. 4 schematically shows an overall implementation architecture of user intent inference in the present disclosure. Referring to FIG. 4, the first operation is an active interaction triggered by the user while accessing the currently displayed content. The active interaction involves actively perceiving the user's needs based on the user's current task and providing real-time knowledge enhancement.

In some embodiments, based on the local knowledge base (Knowledge base retrieval), when the user triggers the first operation such as selecting text (Trigger), the system will actively match the fused features of the selected content, the current paragraph or document context (Content and context), and user behavior data (User Behaviors) with the local knowledge base (Knowledge base retrieval). The processing results are then output to an intent inference model for intent inference (Intent Inferring), thereby understanding the user's current intent of selecting text.

For example, determining user intent may include: further data comparison, a deeper understanding of a concept, tracing the original source of a reference, etc.

The inferred user intent data includes multiple backup intents, as shown in FIG. 4, the data processing method also includes: obtaining the user's selection operation (corresponding to the “√” checkmark in the User Feedback module in FIG. 4), where the selection operation is the operation of selecting at least one backup intent from the at least one backup intent; obtaining the reference data corresponding to the selected backup intent based on the selection operation and outputting the reference data.

In some embodiments, when none of the backup intents reflects the user's true intent, the user can manually input the true intent (corresponding to the dashed box in the User Feedback module in FIG. 4). Therefore, the method may also include: obtaining the user-input intended intent data; obtaining the reference data corresponding to the intended intent data and outputting the reference data (corresponding to the Adaptive Knowledge Augmentation module in FIG. 4).

After the user inputs the true intent, the true intent can be fed back to the intent generation model to enrich and correct the intent interpretation in the next iteration (corresponding to the part of the User Feedback module that is sent back to the Intent Inferring module in FIG. 4). Therefore, the data processing method may also include: feeding back the target intent data to the intent generation model used to output user intent data, to enrich the output types of the intent generation model.

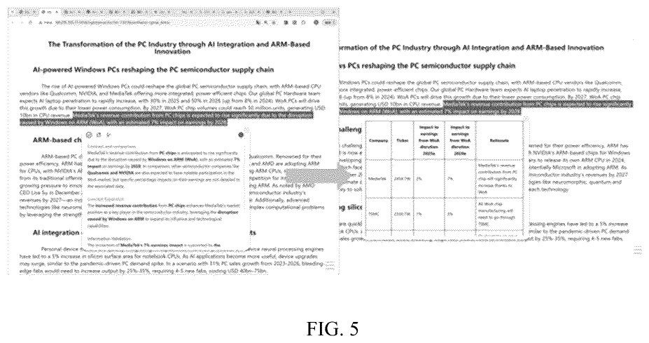

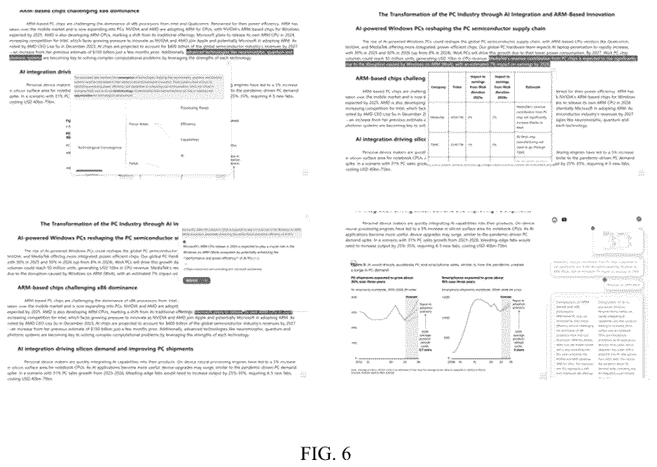

The outputting of the reference data may include: determining the output format of the reference data based on the type of the reference data or the relationship between the reference data and the associated content, and outputting the reference data based on the output format. For example, comparison questions are presented using tables; concept questions are displayed through a knowledge tree; and source tracing questions directly provide web search results, etc. FIG. 5 shows an example of presenting reference data consistent with the present disclosure, and FIG. 6 is another example of presenting display of reference data consistent with the present disclosure. The relevant content can be interpreted in conjunction with FIGS. 5 and 6.

Determining the output format of the reference data based on the type of the reference data or the relationship between the reference data and the associated content makes the presentation of the reference data more intuitive and easier to read, which is conducive to user experience and the speed of task processing.

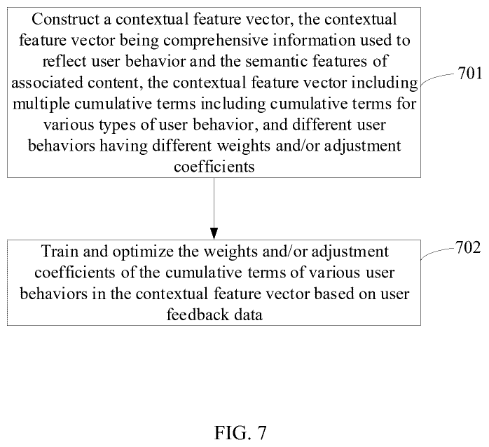

Since different users have different user behavior habits when accessing display content, the method in the embodiments of the present disclosure may also include content for personalizing the data processing solution. FIG. 7 is a flowchart of the personalized adaptation of the data processing solution consistent with the present disclosure. As shown in FIG. 7, the personalization adaptation process includes the following.

At 701, a contextual feature vector is constructed, which is comprehensive information used to reflect user behavior and the semantic features of the associated content. The contextual feature vector includes multiple cumulative terms, including cumulative terms for various types of user behavior. Different user behaviors have different weights and/or adjustment coefficients.

The calculation formula for the contextual feature vector X can be:

$$X = β 1 * ( γ 1 * T\_rel \_view ) + β 2 * ( γ 2 * T\_rel \_input ) + β 3 * S\_select + β 4 * T\_view + β 5 * T\_input + β 6 * H\_hover + β 7 * R\_scroll + β 8 * ( γ 3 * C\_cursor ) + β 9 * E\_eye + Semantic\_Context + ε$$

X is Contextual feature vector, used to reflect comprehensive information of user behavior and semantics. Semantic_Context is Semantic contextual features, semantic embeddings extracted based on the user's current interaction content.
ε is Error term, representing uncaptured randomness or model noise.
β and γ are weights and adjustment coefficients, dynamically optimized based on online learning.

The constraints are:
β3>β1, β2>β4, β5 means mouse selection has the highest weight, followed by relative viewing duration per character and relative input duration per character.
β8>β6, β7 means cursor position changes and page scrolling are more important.
γ1, γ2, γ3>1: high weight processing for contextual differences in relative viewing duration, relative input duration, and cursor position changes.

At 702, the weights and/or adjustment coefficients of the cumulative terms of various user behaviors in the contextual feature vector are trained and optimized based on user feedback data.

Through multiple user feedbacks, the parameters in the formula are trained using an online reinforcement learning method (contextual bandit) under the above constraints, so that the comprehensive understanding efficiency of behavior and semantics is optimized.

The design is as follows:

Since the user interacts with the system in real time, the Contextual Bandit method is selected for training:
1. Contextual features: ‘X’ includes user behavior and semantic features.
2. Intent actions: ‘A={A_1, A_2, . . . , A_k}’, representing all possible intent categories.
3. Reward Function:

```
R(Ai|X) = {
  1, if the user confirms the intent
  0, else
}
```

4. Objective: Select the intent category that maximizes the reward:

$${A}^{*} = arg max A P ( A \vert X )$$

The intent can include, but are not limited to, the following.
Basic intents: Information viewing, content localization, definition and explanation.
Content understanding: Deep reading, contextual association, contradiction or conflict identification.
Information processing: Information filtering, comparison and contrast, summarization and refinement.
Information expansion: Background information retrieval, knowledge graph construction, data verification.
Task orientation: Problem solving, task planning, document proofreading;
Advanced reasoning: Inference and hypothesis, cross-document association, content reorganization;

In some embodiments, intent types can be dynamically added based on the user's query (which can be understood as the user's true intent).

Specifically, the following processes can be performed in sequence:

### 1. Defining the Problem (as in the Previous Section)

Contextual features: User behavior features (quantified data such as viewing duration per character, mouse selection, page scrolling) and semantic features (paragraph semantic embedding).
Action space: Intent categories, such as query, operation, task completion.
Reward: Explicit and implicit feedback after user interaction, used to measure the accuracy of intent prediction.

### 2. Model Framework

Use a Contextual Bandit framework, including contextual features, action space, policy function, and reward function.

The policy function can use Epsilon-Greedy, UCB, or Softmax strategies.

### 3. Algorithm Implementation Processes

At S1, Contextual Feature Extraction:

User behavior features: Relative viewing duration per character, mouse selection, cursor position changes, etc.

Semantic features, calculate the semantic similarity between the current content and the selected content.

Construct a contextual feature vector.

At S2, Action Selection Strategy:

Initialize the policy function and select the optimal action under the current context.
Action value function: Estimate Q(A|X) based on contextual features X and parameters θ.

At S3, Reward Function Definition:
Explicit reward: Reward R=1 when the user confirms the intent.
Implicit Reward: Reward R=0.8 when the user's subsequent behavior aligns with the recommendation intent.

Processes S1-S3 describe the process of model training.

At S4, Online Update:

Collect user feedback and update the action value function:

$$θ\_ \{ t + 1 \} = θ\_t - η \cdot ∇ \_θ L ( Q ( A \vert X ) , R ( A \vert X ) )$$

Adjust the policy function to dynamically optimize prediction accuracy.

Process 4 is the process of optimizing X through A (intent).

At S5, Model Evaluation:
Inference accuracy: Consistency between predicted intent and actual intent.
Cumulative reward value: Records the cumulative reward of the model.
User satisfaction: Based on implicit interaction and explicit ratings.

### 4. Real-Time Optimization Mechanism

Context dynamic adjustment: Monitor new behavior patterns and expand the feature space.
Exploration and exploitation balance: Dynamically adjust the Epsilon value (balance value) to enhance exploration efficiency.
Cross-user transfer learning: Aggregate multi-user behavior patterns to improve intent inference for cold-start users.

Through the above content, the model equipped with the described data processing methods can better adapt to the user behavior of different users, providing users with more comfortable and accurate intent inference.

For the aforementioned embodiments of the methods, for simplicity of description, they are all described as a series of action combinations. However, those skilled in the art should understand that present disclosure is not limited to the described order of actions, some processes can be performed in other orders or simultaneously. Further, those skilled in the art should also understand that the embodiments described in the specification are merely examples of the present disclosure and may be implemented in various forms.

The above embodiments in the present disclosure describe the method in detail. The present disclosure discloses a apparatus, and specific embodiments are given below for detailed description.

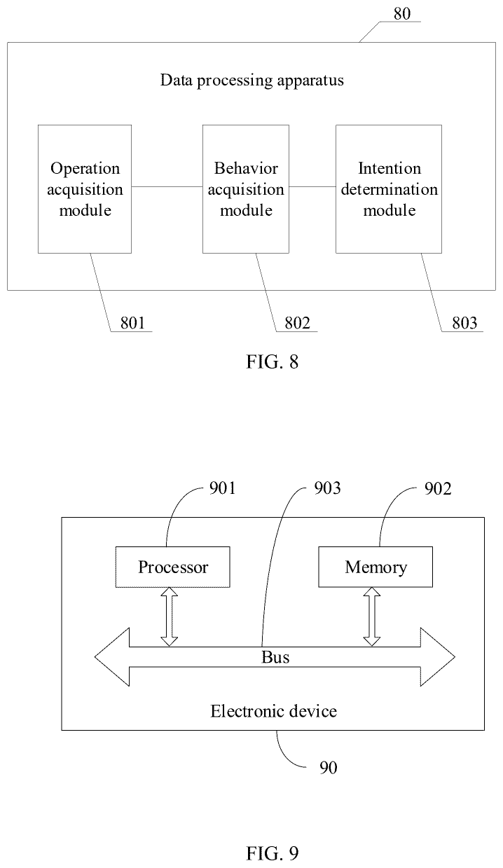

FIG. 8 is a schematic structural diagram of a data processing apparatus consistent with the present disclosure. As shown in FIG. 8, the data processing apparatus 80 includes the following.

An operation acquisition module 801, configured to obtain a first operation triggered by a user on the currently displayed content, where the first operation has associated content.

A behavior acquisition module 802, configured to obtain user behavior data within a specified period based on the first operation, where the user behavior data is implicit interaction data collected based on control operations performed by the user using an input device while accessing the currently displayed content, and the implicit interaction data can reflect the user's interested content.

The intent determination module 803 is configured to determine user intent data based on the user behavior data and the associated content.

Consistent with the present disclosure, when a user triggers a first operation on the currently displayed content, the data processing apparatus obtains user behavior data within a specified period. This user behavior data, incorporated with the associated content of the first operation, is used to comprehensively determine the user's intent. Since the user behavior data is implicit interaction data that can reflect the content the user is interested in, using user behavior data as the basis for determining user intent can further improve the accuracy of intent inference.

In some embodiments, the first operation is a content selection operation, which includes any of the following: box selection, circle selection, highlighting, and underlining; the associated content includes at least the content selected by the content selection operation.

In some embodiments, the behavior acquisition module can be configured to: obtain user behavior data within a specified period before the user triggers the first operation, based on the first operation. The user behavior data includes at least one of the following: current content access status data, cursor movement data, and page scrolling data. The user behavior data has a fixed data structure.

In some embodiments, the intent determination module can be configured to: perform semantic analysis on the associated content to obtain semantic features, fuse the semantic features and the user behavior data to obtain fused features, and perform intent recognition on the fused features and a local knowledge base to determine the user intent.

In some embodiments, the user intent data includes at least one backup intent, and the apparatus may also include: a feedback processing module, configured to obtain the user's selection operation, where the selection operation is an operation of selecting at least one backup intent from the at least one backup intent, and obtain reference data corresponding to the selected backup intent based on the selection operation and output the reference data.

In some embodiments, the apparatus may also include: a feedback processing module, configured to obtain user-input intended intent data, and obtain reference data corresponding to the intended intent data and output the reference data.

In some embodiments, the feedback processing module can be configured to: determine the output format of the reference data based on the type of the reference data or the relationship between the reference data and the associated content, and output the reference data based on the output format.

In some embodiments, the feedback processing module can be configured to: feed the intent data back to the intent generation model used to output user intent data, in order to enrich the output types of the intent generation model.

In some embodiments, the apparatus may also include: an adaptive processing module, configured to: construct a contextual feature vector, where the contextual feature vector is comprehensive information used to reflect user behavior and semantic features of associated content, and the contextual feature vector includes multiple cumulative terms, including cumulative terms for various types of user behavior, the cumulative terms for different user behaviors having different weights and/or adjustment coefficients, and train and optimize the weights and/or adjustment coefficients of the cumulative terms of various user behaviors in the contextual feature vector based on user feedback data.

The specific implementation of the above data processing apparatus and its various modules, as well as other possible implementations, can be found in the corresponding sections of the method embodiments, and will not be repeated here.

Any of the data processing apparatus in the above embodiments includes a processor and a memory. The operation acquisition module, behavior acquisition module, intent determination module, adaptive processing module, feedback processing module, etc., in the above embodiments are all stored as program modules in the memory and executed by the processor to implement the corresponding functions.

The processor includes a kernel, which retrieves the corresponding program modules from the memory. One or more kernels can be provided, and the processing of feedback data can be achieved by adjusting the kernel parameters.

The memory may include non-volatile memory in a computer-readable medium, such as random access memory (RAM) and/or non-volatile memory, such as read-only memory (ROM) or flash RAM. The memory includes at least one memory chip.

In some embodiments, a computer-readable storage medium is also provided, which can be directly loaded into the internal memory of a computer and contains program code. This computer program, when loaded and executed by the computer, can implement the processes shown in any embodiment of the above data processing method.

In some embodiments, a computer program product is also provided, which can be directly loaded into the internal memory of a computer and contains program code. This computer program, when loaded and executed by the computer, can implement the processes shown in any embodiment of the above data processing method.

Furthermore, the present disclosure provides an electronic device. FIG. 9 is a schematic structural diagram of an electronic device in the present disclosure. As shown in FIG. 9, the electronic device 90 includes at least one processor 901, and at least one memory 902 and bus 903 connected to the processor. The processor and memory communicate with each other through the bus, and the processor is configured to call program instructions in the memory to execute the data processing method described above.

The various embodiments in this specification are described in a progressive manner, with each embodiment focusing on the differences from other embodiments. Similar parts between the embodiments can be referred to each other. Since the apparatus in the present disclosure corresponds to the methods disclosed above, relevant details can be found in the method description section.

It should also be noted that, in the present disclosure, relational terms such as “first” and “second” are merely used to distinguish one entity or operation from another entity or operation, and are not used to describe any such actual relationship or order between these entities or operations. Furthermore, the terms “comprise,” “include,” or any other variation thereof are intended to cover non-exclusive inclusion, so that a process, method, article, or device that includes a series of elements not only includes those elements, but also includes other elements not explicitly listed, or elements inherent to such a process, method, article, or device. Without further limitations, an element defined by the phrase “comprising a . . . ” does not exclude the presence of other identical elements in the process, method, article, or device that includes the element.

The processes of the methods or algorithms described in connection with the embodiments disclosed herein may be directly implemented in hardware, software modules executed by a processor, or a combination of both. The software modules may be placed in random access memory (RAM), read-only memory (ROM), electrically programmable ROM, electrically erasable programmable ROM, registers, hard drives, removable disks, CD-ROMs, or any other form of storage medium known in the art.

The above description of the present disclosure enables those skilled in the art to implement or use the present disclosure. Various modifications to the present disclosure will be obvious to those skilled in the art, and the general principles defined herein may be implemented in other embodiments without departing from the spirit or scope of the present disclosure. Therefore, the present disclosure will not be limited to the embodiments shown herein, but rather is intended to cover the broadest scope consistent with the principles and novel features disclosed herein.

What is claimed is:

1. A data processing method comprising:
obtaining an operation by a user on currently displayed content, the operation having associated content;
obtaining user behavior data within a specified period based on the operation, the user behavior data being implicit interaction data collected based on one or more control operations performed by the user using an input device while accessing the currently displayed content, and the implicit interaction data characterizing interested content of the user; and
determining user intent data based on the user behavior data and the associated content.

2. The data processing method according to claim 1, wherein:
the operation is a content selection operation including any one of box selection, circle selection, highlighting, and underlining; and
the associated content includes at least content selected by the content selection operation.

3. The data processing method according to claim 1, wherein obtaining the user behavior data includes:
based on the operation, obtaining user behavior data within a specified period before the user triggers the operation, the user behavior data including at least one of current content access status data, cursor movement data, or page scrolling data, and the user behavior data having a fixed data structure.

4. The data processing method according to claim 1, wherein determining the user intent includes:
performing semantic analysis on the associated content to obtain one or more semantic features;
performing fusion processing on the one or more semantic features and the user behavior data to obtain one or more fused features; and
performing intent recognition on the one or more fused features and a local knowledge base to determine the user intent.

5. The data processing method according to claim 1,
wherein the user intent data includes one or more backup intents;
the method further comprising:
obtaining a selection operation by the user, the selection operation being an operation of selecting at least one backup intent from the one or more backup intents;
obtaining reference data corresponding to the at least one backup intent; and
outputting the reference data.

6. The data processing method according to claim 5, wherein outputting the reference data includes:
determining output format of the reference data based on a type of the reference data or a relationship between the reference data and the associated content; and
outputting the reference data based on the output format.

7. The data processing method according to claim 1, further comprising:
obtaining intended intent data input by the user;
obtaining reference data corresponding to the intended intent data; and
outputting the reference data.

8. The data processing method according to claim 7, wherein outputting the reference data includes:
determining output format of the reference data based on a type of the reference data or a relationship between the reference data and the associated content; and
outputting the reference data based on the output format.

9. The data processing method according to claim 7, further comprising:
feeding back the intended intent data to an intent generation model used for outputting user intent data.

10. The data processing method according to claim 1, further comprising:
constructing a contextual feature vector, the contextual feature vector including comprehensive information configured to reflect user behavior and one or more semantic features of the associated content, and the contextual feature vector including a plurality of cumulative terms, including cumulative terms for various types of user behavior and having different weights and/or adjustment coefficients; and
training and optimizing the weights and/or adjustment coefficients of the cumulative terms of various types of user behavior in the contextual feature vector based on user feedback data.

11. An electronic device comprising:
a processor; and
a memory storing instructions that, when executed by the processor, cause the electronic device to:
obtain an operation by a user on currently displayed content, the operation having associated content;
obtain user behavior data within a specified period based on the operation, the user behavior data being implicit interaction data collected based on one or more control operations performed by the user using an input device while accessing the currently displayed content, and the implicit interaction data characterizing interested content of the user; and
determine user intent data based on the user behavior data and the associated content.

12. The electronic device according to claim 11, wherein:
the operation is a content selection operation including any one of box selection, circle selection, highlighting, and underlining; and
the associated content includes at least content selected by the content selection operation.

13. The electronic device according to claim 11, wherein the instructions, when executed by the processor, further cause the electronic device to, when obtaining the user behavior data includes:
based on the operation, obtain user behavior data within a specified period before the user triggers the operation, the user behavior data including at least one of current content access status data, cursor movement data, or page scrolling data, and the user behavior data having a fixed data structure.

14. The electronic device according to claim 11, wherein the instructions, when executed by the processor, further cause the electronic device to, when determining the user intent:
perform semantic analysis on the associated content to obtain one or more semantic features;
perform fusion processing on the one or more semantic features and the user behavior data to obtain one or more fused features; and
perform intent recognition on the one or more fused features and a local knowledge base to determine the user intent.

15. The electronic device according to claim 11, wherein:
the user intent data includes one or more backup intents; and
the instructions, when executed by the processor, further cause the electronic device to:
obtain a selection operation by the user, the selection operation being an operation of selecting at least one backup intent from the one or more backup intents;
obtain reference data corresponding to the at least one backup intent; and
output the reference data.

16. The electronic device according to claim 15, wherein the instructions, when executed by the processor, further cause the electronic device to, when outputting the reference data:
determine output format of the reference data based on a type of the reference data or a relationship between the reference data and the associated content; and
output the reference data based on the output format.

17. The electronic device according to claim 11, wherein the instructions, when executed by the processor, further cause the electronic device to:
obtain intended intent data input by the user;
obtain reference data corresponding to the intended intent data; and
output the reference data.

18. The electronic device according to claim 17, wherein the instructions, when executed by the processor, further cause the electronic device to, when outputting the reference data:
determine output format of the reference data based on a type of the reference data or a relationship between the reference data and the associated content; and
output the reference data based on the output format.

19. The electronic device according to claim 17, wherein the instructions, when executed by the processor, further cause the electronic device to:
feed back the intended intent data to an intent generation model used for outputting user intent data.

20. A non-transitory computer-readable storage medium storing a computer program that, when executed by one or more processors, causes the one or more processors to:
obtain an operation by a user on currently displayed content, the operation having associated content;
obtain user behavior data within a specified period based on the operation, the user behavior data being implicit interaction data collected based on one or more control operations performed by the user using an input device while accessing the currently displayed content, and the implicit interaction data characterizing interested content of the user; and
determine user intent data based on the user behavior data and the associated content.
